(19) United States
(12) Patent Application Publication
(10) Pub. No.: US 2013/0097276 A1
(43) Pub. Date: Apr. 18, 2013

(54) CLOUD COMPUTING INTEGRATION FOR SENSOR NETWORKS

(71) Applicant: Bharath Sridhar, Bangalore (IN)

(72) Inventor: Bharath Sridhar, Bangalore (IN)

(73) Assignee: Unisys Corp., Blue Bell, PA (US)

(21) Appl. No.: 13/272,287

(22) Filed: Oct. 13, 2011

(51) Int. Cl. G06F 15/16

(52) U.S. Cl. 709/217

(57) ABSTRACT

A sensor network may be coupled to a cloud computing system for improved reliability, flexibility, and functionality. The sensor network may communicate with the cloud computing system through a coordinator gateway device through a wireless network. Data recording and data processing is offloaded from the individual sensors to the cloud computing system, which has significantly better reliability and processing capability and is not restricted by battery life. The recorded and processed data residing on the cloud computing system may be viewed, manipulated and modified through a client device displaying an application, web page, and/or application program interface (API).

### TECHNICAL FIELD

The instant disclosure relates to cloud computing. More specifically, the instant disclosure relates to integrating sensors networks with cloud computing.

### BACKGROUND

Sensors for monitoring parameters are found nearly everywhere in developed civilizations. For example, rooms in a building may include motion sensors for detecting motion and turning on lights. In another example, hallways in a building may include motion sensors to activate security cameras. In yet another example, outdoor temperature sensors scattered throughout a city may be used for weather prediction and historical recording. The large number of sensors already deployed in various environments are accompanied by a large number of different protocols, software applications, and servers for monitoring, recording, and processing data received from the sensors and making decisions based on received data. The proprietary nature of interfaces for sensors creates very little interaction between software applications and server for accessing different types of sensors. Additionally, conventional sensor networks coupled to a dedicated server or proprietary system have a single point of failure, which reduces reliability.

The sensors are conventionally dummy devices, which only measure parameters of the environment. Designing additional processing capability into a sensor may significantly increase the cost of the sensor. Any increase in the cost of a single sensor has a multiplicative effect on the total cost of a sensor network, because a sensor network may contain hundreds or thousands of sensors. Processing of data with the sensor is thus prohibited by cost. Additional processing capability on sensors also increases power consumption, which creates a problem for battery-powered sensors.

### SUMMARY

According to one embodiment, a method includes activating a sensor to obtain data. The method also includes receiving data from the sensor at a cloud computing system. The method further includes transmitting a display of the data from the cloud computing system to a client device.

According to another embodiment, a computer program product includes a non-transitory computer readable medium having code to activate a sensor to obtain data. The medium also includes code to receive data from the sensor at a cloud computing system. The medium further includes code to transmit a display of the data from the cloud computing system to a client device.

According to yet another embodiment, a system including a sensor network. The system also includes a cloud computing system. The system further includes a client device.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a block diagram illustrating an integration of a wireless sensor network with cloud computing according to one embodiment of the disclosure.

FIG. 2 is a flow chart illustrating a method of communicating between a wireless sensor network and a cloud computing system according to one embodiment.

FIG. 3 is a block diagram illustrating an interface for monitoring the wireless sensor network through the cloud computing system on a client device according to one embodiment of the disclosure.

FIG. 4 is a block diagram illustrating communication between a wireless sensor network and a cloud computing system in a technology center according to one embodiment of the disclosure.

FIG. 5 is a block diagram illustrating communication between a wireless sensor network and a cloud computing system in a hospital according to one embodiment of the disclosure.

FIG. 6 is a block diagram illustrating communication between a wireless sensor network and a cloud computing system for an environment monitoring system according to one embodiment of the disclosure.

FIG. 7 is block diagram illustrating a data management system configured to store databases, tables, and/or records according to one embodiment of the disclosure.

FIG. 8 is a block diagram illustrating a data storage system according to one embodiment of the disclosure.

FIG. 9 is a block diagram illustrating a computer system according to one embodiment of the disclosure.

### DETAILED DESCRIPTION

Sensor networks may be adapted to communicate with cloud computing systems to improve reliability, flexibility, and capability of the sensor networks. According to one embodiment, the sensor networks may be wireless sensor networks. Data stored in a cloud computing system is more accessible than data stored on dedicated servers or proprietary systems coupled to conventional sensor networks. For example, data stored in cloud computing system may be accessed by numerous and various client devices including mobile devices such as laptops and cellular phones. Additionally, cloud computing systems are more reliable than dedicated server configurations such that measurements sampled by the sensor networks is more likely to be recorded and/or processed. For example, with a dedicated server if the server becomes unavailable data recorded by the sensor network is lost. In the case of medical sensors recording life-signs, the lost data may result in incorrect treatment decisions. In the case of temperature sensors on computer equipment, lost data may result in damaged computer equipment and downtime for other network services. Cloud computing systems for recording measurements from sensor networks may also be more economical than dedicated servers, because cloud computing systems are often pay-per-use not requiring the purchase of large amounts of computer equipment to handle peak demand.

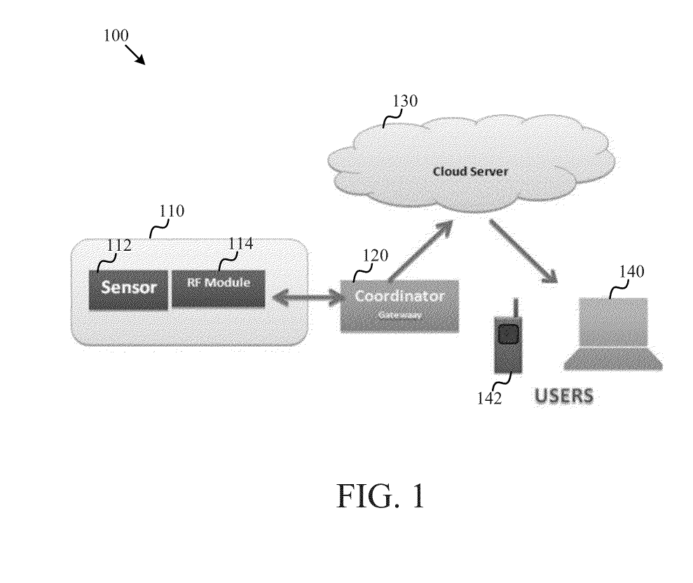

One embodiment of a sensor network coupled to a cloud computing system is described with reference to FIG. 1. FIG. 1 is a block diagram illustrating an integration of a wireless sensor network with cloud computing. A sensor network 110 may include a sensor 112 coupled to a radio frequency (RF) module 114. Although not shown, the sensor network 110 may include additional sensors and RF modules. The RF module 114 receives data from the sensor 112 and transmits the data to a coordinator gateway 120. According to one embodiment, the coordinator gateway 120 may be, for example, a wireless network access point (WAP). In this embodiment, the RF module 114 may be a WiFi transmitter operating in the unlicensed radio spectrum. According to another embodiment, the coordinator gateway 120 may be a cellular telephone base station. In this embodiment, the RF module 114 may be a general packet radio service (GPRS) radio, global systems for mobile communications (GSM) radio, code division multiple access (CDMA) radio, or other second generation (2G), third generation (3G) radio, fourth generation (4G) radio, or subsequent generation radio. The coordinator gateway 120 may be assigned to the sensor network 110, or the coordinator gateway 120 may be geographically-located within transmission range of the RF module 114.

According to one embodiment, the coordinator gateway 120 may perform pre-processing of data received from the sensor network 110. For example, the coordinator gateway 120 may average measurements received from the sensor 112 and other sensors in the sensor network 110. As another example, the coordinator gateway 120 may perform compression or other encoding of the data. The coordinator gateway 120 may transmit the raw data received from the sensor network 110 and/or the pre-processed data to a cloud computing system 130. The coordinator gateway 120 may transmit data to the cloud computing system 130 using the transmission control protocol/internet protocol (TCP/IP). According to one embodiment, data transmitted to the cloud computing system 130 is encrypted.

The coordinator gateway 120 may not send all received data to the cloud computing system 130. Instead, the coordinator gateway 120 may have a detection algorithm to detect certain events and send an alert to the cloud computing system 130 and/or send only the detected data. For example, the coordinator gateway 120 may be configured to detect spikes in measured data received from the sensor network 110. According to another embodiment, the spike detection may be configured on the sensor 112 such that the sensor 112 only transmits measured parameters that have spiked beyond a configured threshold.

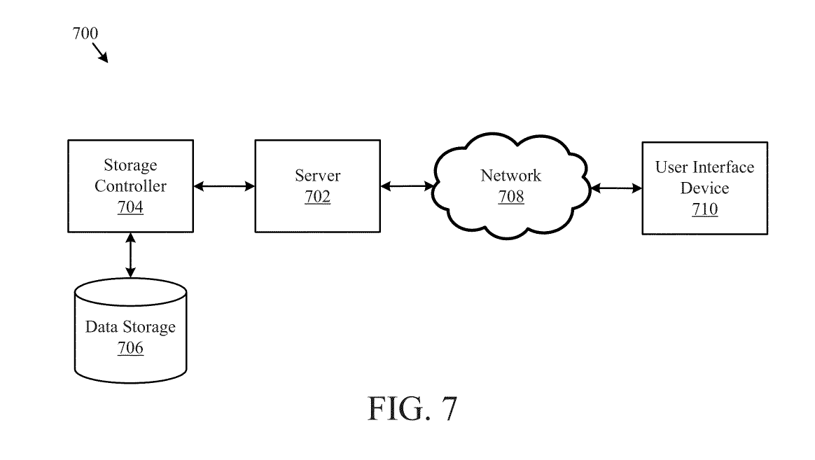

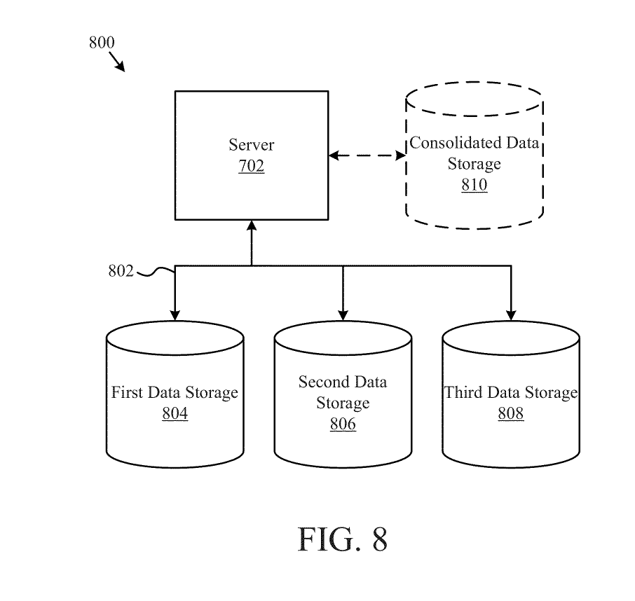

The cloud computing system 130 receives the data from the coordinator gateway 120 and records the data. The data may be recorded in databases as discussed below with reference to FIG. 7 and FIG. 8. According to one embodiment, the cloud computing system 130 may perform processing of the data. Data processing at the cloud computing system 130 may be advantageous because the processing capability of the cloud computing system 130 may be much greater than the processing capability of either the coordinator gateway 120 or the sensor 112. By moving processing functions to the cloud computing system 130, the sensor 112 and the coordinator gateway 120 may be manufactured with cheaper components and reduce the cost of the sensor 112 and the coordinator gateway 120. Processing on the cloud computing system 130 may include data analysis such as data validation, data cleaning, and/or data transformation. The processing may be performed automatically or manually under control of a user and/or administrator of the cloud computing system 130.

According to one embodiment, the sensor 112 may transmit data directly to the cloud computing system 130. In this embodiment, the coordinator gateway 120 may be absent or the coordinator gateway 120 may assume other roles. For example, the coordinator gateway 120 may issue commands to configure and/or provision the sensor 112 and/or the RF module 114. In this embodiment, either the coordinator gateway 120 or the cloud computing system 130 may activate a sensor 112 through the RF module 114 to obtain a measurement.

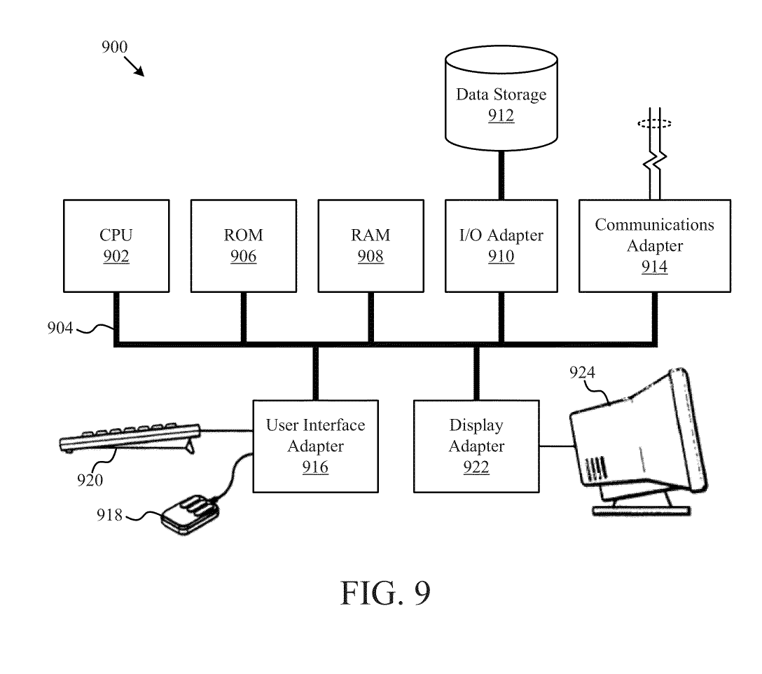

Client devices such as a computer 140 and a mobile phone 142 may be coupled to the cloud computing system 130. More description of the client devices 140 and 142 is provided below with reference to FIG. 9. The client devices 140 and 142 may have access to display, modify, delete, and/or manipulate data in the cloud computing system 130 including data received from the sensor network 110, the coordinator gateway 120, and other data stored within the cloud computing system 130. The client devices 140 and 142 may also direct requests for measurements to any, some, or a single sensor within the sensor network 110. Additionally, the client devices 140 and 142 may configure and/or provision any sensor in the sensor network 110 or the coordinator gateway 120. For example, the client devices 140 and 142 may configure pre-processing performed by the coordinator gateway 120. In another example, the client devices 140 and 142 may configure the sensor 112 to perform measurements at specified intervals such as every hour or every day. According to one embodiment, access controls may be placed on the client devices 140 and 142 such that certain client devices are only capable of viewing data or processing data and are restricted from configuring and/or provisioning sensors and gateways.

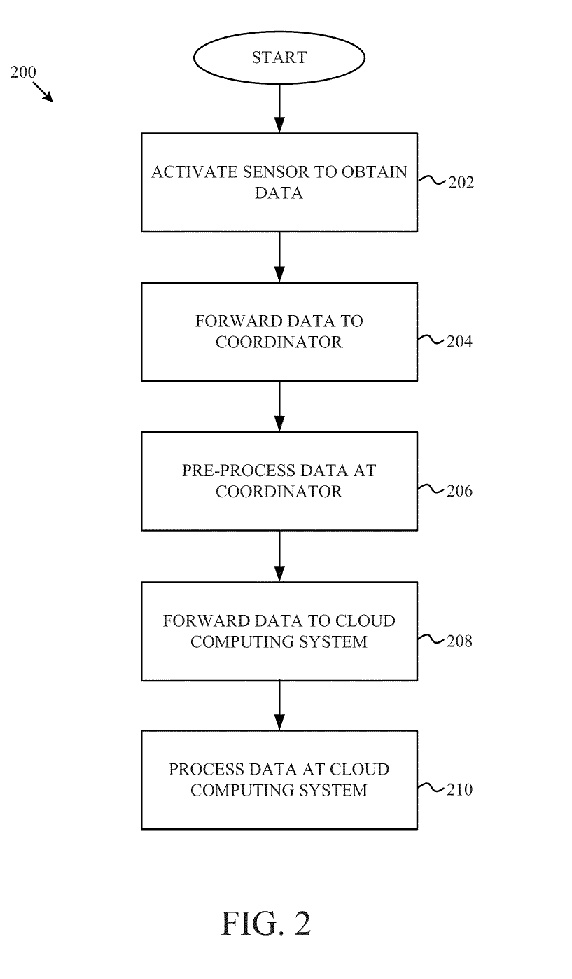

FIG. 2 is a flow chart illustrating a method of communicating between a wireless sensor network and a cloud computing system according to one embodiment. A method 200 begins at block 202 with activating a sensor in a sensor network to obtain data. At block 204 the data may be forwarded to a coordinator gateway. At block 206 the coordinator gateway may perform pre-processing on the data such as, for example, compression or encoding. At block 208 the coordinator gateway may forward the raw data and/or pre-processed data to a cloud computing system. At block 210 the cloud computing system may perform further processing on the data.

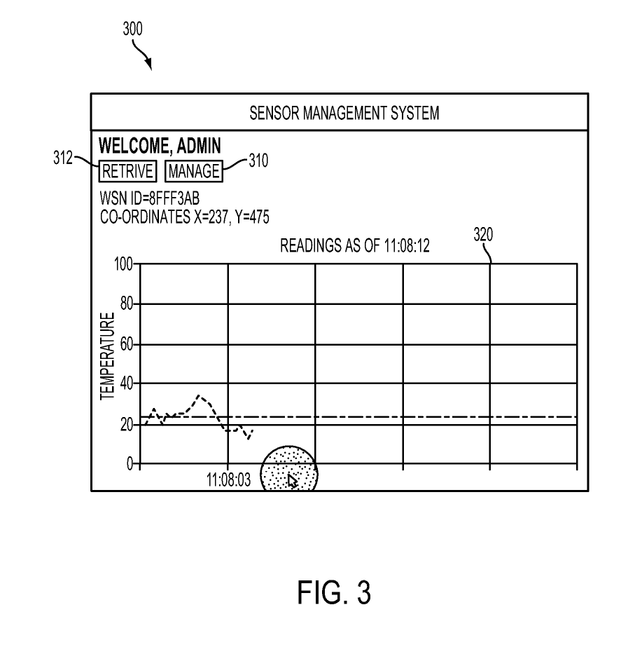

A client device may view and process sensor measurement data in a cloud computing system and configure sensors through a computer program, a web site, and/or an application programming interface (API). FIG. 3 is a block diagram illustrating an interface for monitoring the wireless sensor network through the cloud computing system on a client device according to one embodiment of the disclosure. An interface 300 includes a graph 320 displaying data measured by a sensor and received by a cloud computing system. The data in the graph 320 may be pre-processed by a coordinator gateway and/or processed by the cloud computing system. A user may request additional processing by the cloud computing system through the interface 300. The user may also request to retrieve new data from a sensor through a retrieve command button 312. The user may also request to manage the sensor, the sensor network, and/or the coordinator gateway through a manage command button 310. The command buttons 310 and 312 may launch new interfaces or applications for performing the requested functions. According to one embodiment, the user may manipulate the data in the graph 320 and save the manipulated data to the cloud computing system as a new copy of the sensor data or as a replacement of the original sensor data. The user may also export the data from the cloud computing system to a new format, such as a spreadsheet.

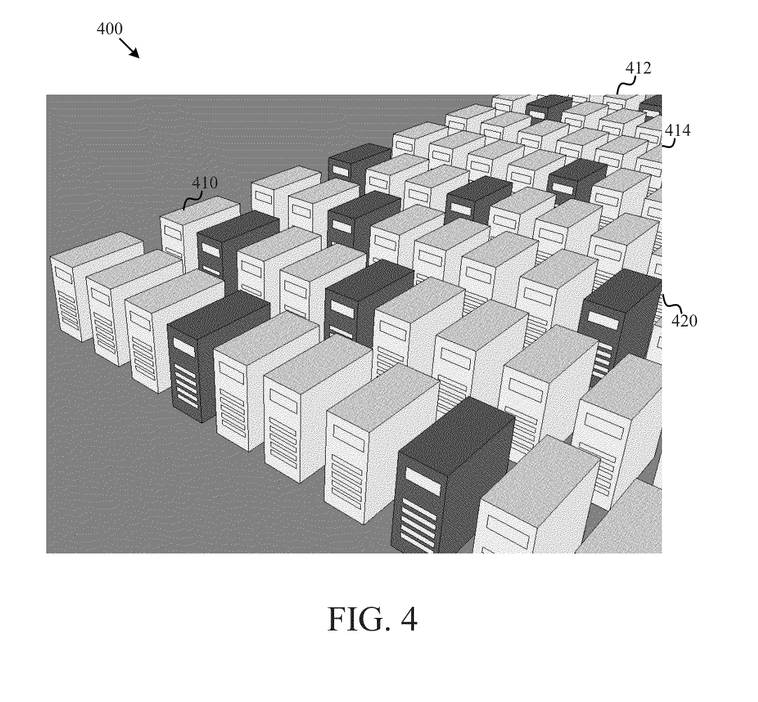

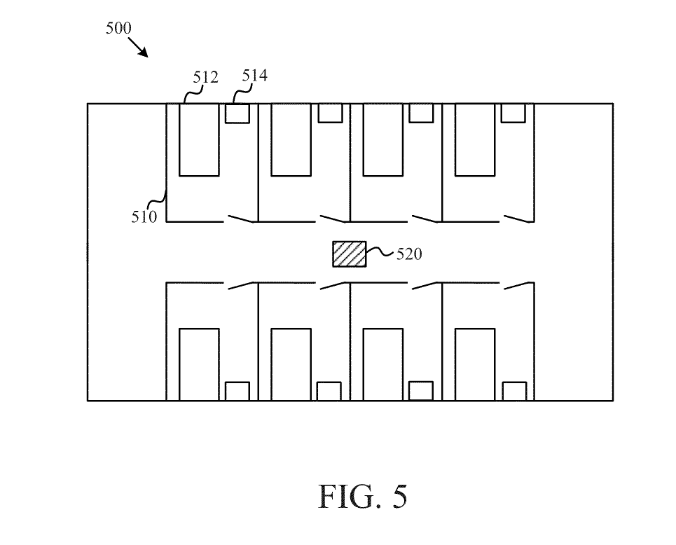

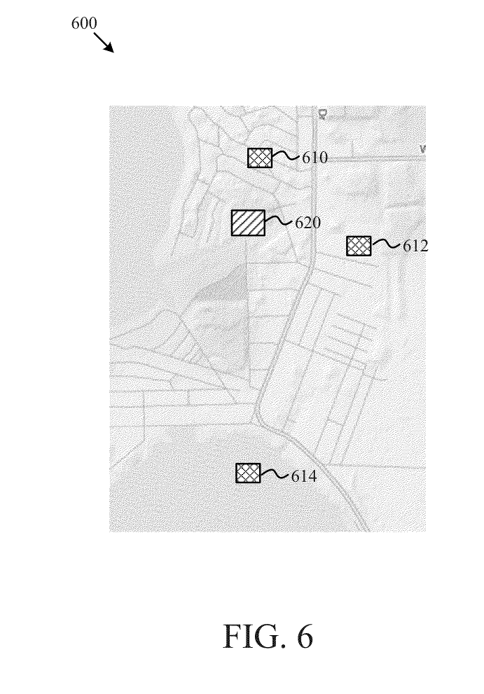

Examples of cloud computing applications including computer farm monitoring, patient monitoring in hospitals, and environment quality monitoring for a sensor network are described below with reference to FIG. 4, FIG. 5, and FIG. 6, respectively.

FIG. 4 is a block diagram illustrating communication between a wireless sensor network and a cloud computing system in a technology center according to one embodiment of the disclosure. A computer farm 400 includes a number of computer systems 410, 412, 414, and 420. The computer systems 410, 412, 414, and 420 may be a part of a cloud computing system or they may be discrete computer servers. Areas with a high density of computer equipment, such as the computer farm 400, may have specific requirements for environmental control. For example, a temperature in the environment of the computer farm 400 may be kept within a certain range for optimum performance of the computer farm 400 or to prevent damage to the computer systems 410, 412, 414, and 420 of the computer farm 400. Sensors (not shown) may be located within each of the computer systems 410, 412, 414, and 420. The sensors may monitor a temperature within each of the computer systems 410, 412, 414, and 420 or monitor a component, such as a processor, within each of the computer systems 410, 412, 414, and 420. The sensors may communicate with a coordinator gateway (not shown), as described with reference to FIG. 1, allowing a cloud computing system that receives the data to determine that the computer system 420 has overheated. A client device may be monitoring the data or may receive an alert generated by the cloud computing system indicating the overheat condition.

Another example application of a sensor network coupled to a cloud computing system is for patient monitoring within a hospital or other healthcare facility. FIG. 5 is a block diagram illustrating communication between a wireless sensor network and a cloud computing system in a hospital according to one embodiment of the disclosure. A health care building 500 may include a number of rooms 510. The rooms 510 may include a patient bed 512 and a sensor 514. The sensor 514 may measure patient life-signs such as heart rate, blood pressure, oxygen saturation, blood sugar, pulse, weight, and/or intravenously-administered drugs. The sensor 514 may communicate with a coordinator gateway 520 in the building 500. For example, the coordinator gateway 520 may be mounted in the hallway or placed above a false ceiling out of view of hospital patients and visitors. The coordinator gateway 520 receives data from the sensors 514 and forwards the data to a cloud computing system (not shown). According to one embodiment, the sensor 514 may be coupled to a wired port, such as an Ethernet port, for coupling the sensor 514 to the coordinator gateway 520 or a cloud computing system.

Cloud computing systems coupled with sensor networks may also be used for environmental monitoring. FIG. 6 is a block diagram illustrating communication between a wireless sensor network and a cloud computing system for an environment monitoring system according to one embodiment of the disclosure. A sensor network 600 includes a number of sensors 610, 612, and 614 coupled to a coordinator gateway 620, which may be located centrally to the sensor network 600. Each of the sensors 610, 612, and 614 may be field-based sensors including air, soil, and/or water sensors for monitoring pollution or other environmental parameters such as weather, temperature, humidity, and/or rainfall. The sensors 610, 612, and 614 may communicate data to the coordinator gateway 620 through a wireless network such as a cellular telephone system or a wireless data network such as WiFi.

FIG. 7 illustrates one embodiment of a system 700 for an information system. The system 700 may include a server 702, a data storage device 706, a network 708, and a user interface device 710. The server 702 may be a dedicated server or one server in a cloud computing system. In a further embodiment, the system 700 may include a storage controller 704, or storage server configured to manage data communications between the data storage device 706, and the server 702 or other components in communication with the network 708. In an alternative embodiment, the storage controller 704 may be coupled to the network 708.

In one embodiment, the user interface device 710 is referred to broadly and is intended to encompass a suitable processor-based device such as a desktop computer, a laptop computer, a personal digital assistant (PDA) or table computer, a smartphone or other a mobile communication device or organizer device having access to the network 708. In a further embodiment, the user interface device 710 may access the Internet or other wide area or local area network to access a web application or web service hosted by the server 702 and provide a user interface for enabling a user to enter or receive information.

The network 708 may facilitate communications of data between the server 702 and the user interface device 710. The network 708 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate, one with another.

In one embodiment, the user interface device 710 accesses the server 702 through an intermediate sever (not shown). For example, in a cloud application the user interface device 710 may access an application server. The application server fulfills requests from the user interface device 710 by accessing a database management system (DBMS). In this embodiment, the user interface device 710 may be a computer executing a Java application making requests to a JBOSS server executing on a Linux server, which fulfills the requests by accessing a relational database management system (RDMS) on a mainframe server.

In one embodiment, the server 702 is configured to store databases, pages, tables, and/or records. For example, the server 702 may record measured data from a sensor network in records of a database. Additionally, scripts on the server 702 may access data stored in the data storage device 706 via a Storage Area Network (SAN) connection, a LAN, a data bus, or the like. The data storage device 706 may include a hard disk, including hard disks arranged in an Redundant Array of Independent Disks (RAID) array, a tape storage drive comprising a physical or virtual magnetic tape data storage device, an optical storage device, or the like. The data may be arranged in a database and accessible through Structured Query Language (SQL) queries, or other data base query languages or operations.

FIG. 8 illustrates one embodiment of a data management system 800 configured to store measured data from a sensor network. In one embodiment, the data management system 800 may include the server 702. The server 702 may be coupled to a data-bus 802. In one embodiment, the data management system 800 may also include a first data storage device 804, a second data storage device 806, and/or a third data storage device 808. In further embodiments, the data management system 800 may include additional data storage devices (not shown). In such an embodiment, each data storage device 804, 806, and 808 may each host a separate database that may, in conjunction with the other databases, contain redundant data. Alternatively, a database may be spread across storage devices 804, 806, and 808 using database partitioning or some other mechanism. Alternatively, the storage devices 804, 806, and 808 may be arranged in a RAID configuration for storing a database or databases through may contain redundant data. Data may be stored in the storage devices 804, 806, 808, 810 in a database management system (DBMS), a relational database management system (RDMS), an Indexed Sequential Access Method (ISAM) database, a Multi Sequential Access Method (MSAM) database, a Conference on Data Systems Languages (CODASYL) database, or other database system.

In one embodiment, the server 702 may submit a query to select data from the storage devices 804 and 806. The server 702 may store consolidated data sets in a consolidated data storage device 810. In such an embodiment, the server 702 may refer back to the consolidated data storage device 810 to obtain a set of records. Alternatively, the server 702 may query each of the data storage devices 804, 806, and 808 independently or in a distributed query to obtain the set of data elements. In another alternative embodiment, multiple databases may be stored on a single consolidated data storage device 810.

In various embodiments, the server 702 may communicate with the data storage devices 804, 806, and 808 over the data-bus 802. The data-bus 802 may comprise a Storage Area Network (SAN), a Local Area Network (LAN), or the like. The communication infrastructure may include Ethernet, Fibre-Chanel Arbitrated Loop (FC-AL), Fibre-Channel over Ethernet (FCoE), Small Computer System Interface (SCSI), Internet Small Computer System Interface (iSCSI), Serial Advanced Technology Attachment (SATA), Advanced Technology Attachment (ATA), Cloud Attached Storage, and/or other similar data communication schemes associated with data storage and communication. For example, the server 702 may communicate indirectly with the data storage devices 804, 806, 808, and 810 by first communicating with a storage server (not shown) or the storage controller 704.

The server 702 may include modules for interfacing with the data storage devices 804, 806, 808, and 810, interfacing a network 708, interfacing with a user through the user interface device 710, and the like. In a further embodiment, the server 702 may host an engine, application plug-in, or application programming interface (API).

FIG. 9 illustrates a computer system 900 adapted according to certain embodiments of the server 702 and/or the user interface device 710. The central processing unit (“CPU”) 902 is coupled to the system bus 904. The CPU 902 may be a general purpose CPU or microprocessor, graphics processing unit (“GPU”), and/or microcontroller. The present embodiments are not restricted by the architecture of the CPU 902 so long as the CPU 902, whether directly or indirectly, supports the modules and operations as described herein. The CPU 902 may execute the various logical instructions according to the present embodiments.

The computer system 900 also may include random access memory (RAM) 908, which may be SRAM, DRAM, SDRAM, or the like. The computer system 900 may utilize RAM 908 to store the various data structures used by a software application such as databases, tables, and/or records. The computer system 900 may also include read only memory (ROM) 906 which may be PROM, EPROM, EEPROM, optical storage, or the like. The ROM may store configuration information for booting the computer system 900. The RAM 908 and the ROM 906 hold user and system data.

The computer system 900 may also include an input/output (I/O) adapter 910, a communications adapter 914, a user interface adapter 916, and a display adapter 922. The I/O adapter 910 and/or the user interface adapter 916 may, in certain embodiments, enable a user to interact with the computer system 900. In a further embodiment, the display adapter 922 may display a graphical user interface associated with a software or web-based application on a display device 924, such as a monitor or touch screen.

The I/O adapter 910 may connect one or more storage devices 912, such as one or more of a hard drive, a compact disk (CD) drive, a floppy disk drive, and a tape drive, to the computer system 900. The communications adapter 914 may be adapted to couple the computer system 900 to the network 708, which may be one or more of a LAN, WAN, and/or the Internet. The communications adapter 914 may be adapted to couple the computer system 900 to a storage device 912. The user interface adapter 916 couples user input devices, such as a keyboard 920, a pointing device 918, and/or a touch screen (not shown) to the computer system 900. The display adapter 922 may be driven by the CPU 902 to control the display on the display device 924.

The applications of the present disclosure are not limited to the architecture of computer system 900. Rather the computer system 900 is provided as an example of one type of computing device that may be adapted to perform the functions of a server 702 and/or the user interface device 710. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
activating a sensor to obtain data;
receiving data from the sensor at a cloud computing system; and
transmitting a display of the data from the cloud computing system to a client device.

2. The method of claim 1, in which the step of receiving the data from the sensor comprises receiving the data from a coordinator gateway coupled to the sensor.

3. The method of claim 1, further comprising processing data at the cloud computing system.

4. The method of claim 1, in which the step of transmitting the display of the data to the client device comprises transmitting to a mobile device.

5. The method of claim 1, further comprising transmitting a new configuration for the sensor.

6. The method of claim 5, in which the step of transmitting the new configuration for the sensor comprises transmitting the new configuration to a coordinator gateway.

7. The method of claim 1, in which the sensor is at least one of a plurality of sensors comprising a sensor network.

8. The method of claim 7, in which the sensor network monitors at least one of a computing system, a patient, and/or an environment.

9. A computer program product, comprising:
a non-transitory computer readable medium comprising:
code to activate a sensor to obtain data;
code to receive data from the sensor at a cloud computing system; and
code to transmit a display of the data from the cloud computing system to a client device.

10. The computer program product of claim 9, in which the code to receive the data from the sensor comprises code to receive the data from a coordinator gateway coupled to the sensor.

11. The computer program product of claim 10, in which the data received from the coordinator gateway is pre-processed.

12. The computer program product of claim 9, in which the medium further comprises processing data at the cloud computing system.

13. The computer program product of claim 9, in which the code to transmit the display of the data to the client device comprises code to transmit a display interface to a mobile device.

14. The computer program product of claim 9, in which the medium further comprises code to transmit a new configuration for the sensor.

15. The computer program product of claim 9, in which the code to transmit the new configuration for the sensor comprises code to transmit the new configuration to a coordinator gateway.

16. A system, comprising:
a sensor network;
a cloud computing system; and
a client device.

17. The system of claim 16, in which the sensor network comprises a plurality of sensors, in which each sensor comprises a radio frequency (RF) transmitter.

18. The system of claim 17, in which the RF transmitter comprises at least one of a wireless network transmitter and a cellular network transmitter.

19. The system of claim 16, in which the client device comprises at least one of a personal data assistant (PDA), a tablet computer, a smartphone, a computer game console, and a laptop computer.

20. The system of claim 16, further comprising a coordinator gateway for forwarding data from the sensor network to the cloud computing system.
